(19) United States
(12) Patent Application Publication
(10) Pub. No.: US 2002/0030868 A1
(43) Pub. Date: Mar. 14, 2002

(54) Monitoring of signal wavelengths in optical fiber

(76) Inventor: Ari Salomaa, Espoo (FI)

Correspondence Address: Michael B. Lasky, Altera Law Group, Suite 100, 6500 City West Parkway, Minneapolis, MN, 55344-7701, US

(21) Appl. No.: 09/885,387

(22) Filed: Jun. 20, 2001

Related U.S. Application Data
(63) Continuation of application No. PCT/FI99/01087, filed on Dec. 28, 1999.

(30) Foreign Application Priority Data
Dec. 31, 1998 (FI) 982841

(51) Int. Cl. H04J 14/02

(52) U.S. Cl. 359/124

(57) ABSTRACT

Individual wavelengths (λ₁, λ₂, λ₃, . . . λ_{N}) of a multicomponent light wave travelling in an optical fibre are monitored in such a way that e.g. a coupler is used to separate aside from the power of the light wave a small part, which is conducted into a narrowband tuneable optical filter. The filter tuning signal is used for controlling the filter in such a way that the wavelength window formed by its pass band will scan the entire wavelength range to be examined. The narrow-band optical signal obtained from the filter is conducted to a light detector, which converts the optical signal into an electric signal. As the window of the tuneable filter scans through the wavelength band, such an electric signal is obtained as a wavelength function which is proportional to the power of the optical signal and the peak points of which are located at the wavelength of each channel. Based on the control signal and the peak points, the control electronics circuit determines the individual wavelengths of the multicomponent light wave.

### FIELD OF THE INVENTION

The invention relates generally to optical transmission systems using wavelength division multiplexing, especially to monitoring of wavelengths of the channels in the optical fibre.

### BACKGROUND OF THE INVENTION

In Wavelength Division Multiplexing WDM, several independent transceiver couples use the same fibre, and each couple uses a wavelength of its own, which is different from the other wavelengths

FIG. 1 illustrates the principle of wavelength division multiplexing. The example used is a four-channel system, wherein the wavelengths are λ₁, λ₂, λ₃ and λ₄ respectively. The transmission and reception channels are on their own optical fibres. At each end of the optical transmission line there are four transceiver units, of which the transmitter is marked generally as Tx and the receiver as Rx. Transmitter TX1 transmits on wavelength λ₁ and receiver RX1 receives on the same wavelength, but from a different fibre than the one to which the transmitter transmits. The other couples use wavelengths of their own in a similar manner.

The wavelengths produced by the transmitters located at the left end of fibre 8 are combined in an optical multiplexer 1 and they are then conducted to the same optical fibre 8. Correspondingly, the wavelengths produced by the transmitters located at the right end of fibre 9 are combined in optical multiplexer 3 and they are then conducted to the same optical fibre 9. The WDM demultiplexers 2 and 4 at the fibre ends separate from each other the different spectral components of the combined signal arriving from the fibre. Of these signals each one is detected by its own receiver RX1, . . . RX4. Thus, a narrow wavelength window in a certain wavelength range is made available to the signal of each source. The International Tele-communication Union ITU-T has standardised the 1550 nm band for use in optical connections in such a way that the band begins from a frequency of 191.5 THz (1565.50 nm) and continues in steps of 100 GHz up to a frequency of 195.9 THz (1530.33 nm).

The wavelength response of the WDM demultiplexer filter is of a character as shown in FIG. 2. In this example, eight wavelengths (channels) arrive at the filter. The mean wavelength of the band is 1547.72 nm and the channel raster is either the densest 100 GHz as standardised by the ITU-T, which is equal to a wavelength of approximately 0.8 nm, or it may be some multiple desired by the manufacturer, e.g. 200 GHz. It can be concluded from the figure that the filter must be very stable.

It is very important from the viewpoint of the transmission system that the transmitter's wavelength remains stable and sufficiently close to the mean wavelength of the filter at all filter temperatures. The temperature is the most important factor affecting the laser wavelength, and for this reason arrangements are used on the chip for keeping the temperature as stable as possible.

Distributed feedback laser DFB is used very much in the tele-communications technology, both in trunk networks and in distribution networks. Its major parts are the laser diode, the thermistor and the cooler, all integrated on the same chip. The function of the cooler is based on a

use of electric current to bring about a temperature difference. Based on temperature information provided by the thermistor, the outer control circuit controls the cooler either to cool or to heat the laser, so that its temperature and wavelength will remain stable despite any changes in the ambient temperature.

It is also known to measure the laser wavelength by placing within the laser module components which measure the wavelength and the measuring results of which are used for controlling e.g. the cooling element in such a way that the correct wavelength is maintained.

These known procedures make possible a transmitter producing a very stable light wave. However, they do not guarantee an exactly correct wavelength in a situation where the wavelength stabilisation circuit is defective. In such a case it may happen that the wavelength of the light wave will drift a bit to one side of the mean frequency, but not so much that the filters on the transmission path (see FIG. 2) would entirely prevent the light wave from propagating. However, the signal will be considerably attenuated. The transmitter's defective operation could be noticed, if it would be possible at a desired point of the fibre to confirm the correct wavelength of the light wave propagating along the optical fibre. On the other hand, in some situations it ought to be possible to examine the optical fibre in order to find out how many channels there are in the fibre and which wavelengths the channels have. One problem is that the wavelength to be examined is not always known in advance and another problem is that after multiplexing several light waves propagate on the optical fibre, and the number and wavelength of these light waves are unknown. To be able to measure the wavelength of an individual component, a sum wave must be conducted to a demultiplexer, which will split up the sum wave into individual light waves.

It is a drawback when using a multiplexer that it is wavelength sensitive, In other words, it separates only predetermined wavelengths from each other. This is due to the fact that in the division the reflection surfaces in the multiplexer are dimensioned to reflect apart only exactly predetermined wavelengths from the sum wave. To be able by using a multiplexer to divide the wavelengths apart from each other, it must thus be known how many different channels there are in the fibre and which wavelengths they have.

It is an objective of the present invention to bring about an arrangement, by the use of which it is possible to measure in as simple a manner as possible and using a multipurpose unit the number and wavelengths of channels in an optical fibre as well as their relative and absolute power differences. The obtained measuring results can be used for any purpose, such as for monitoring and controlling the wavelengths of laser transmitters.

The established objective is achieved with the attributes described in the independent claims.

### BRIEF SUMMARY OF THE INVENTION

The invention is based on the idea that from a multicomponent light wave travelling along an optical fibre a small part is branched off, which is conducted into a narrowband tuneable optical filter. The filter is controlled in such a way that the wavelength window forming its pass band will scan the entire wavelength range to be monitored. The width of the wavelength windowis very narrow, smaller than the modulation band of the optical channel. The narrowband optical signal obtained from the filter is conducted to a detector, which will convert the optical signal into an electric signal.

As the window of the controlled filter scans through the wavelength band, an electric power proportional to the power of the optical signal is obtained as a function of the wavelength. The peaks of the power curve are located at the wavelength of each channel.

A control electronics circuit performs the necessary computing and control. It is advantageous to include a memory in the equipment, in which the obtained power curve is stored in digital form for a possible later processing.

In order to ensure faultless operation the filter must be calibrated, unless the wavelength of the output signal of the optical filter is exactly known as a function of the control signal. For this reason, preferable calibration methods are also presented.

### BRIEF DESCRIPTION OF THE DRAWINGS

The invention will be described in grater detail with the aid of the enclosed schematic drawings, wherein

FIG. 1 shows a WDM transmission system,

FIG. 2 shows attenuation of the multiplexer,

FIG. 3 is a block diagram of a monitor in accordance with the invention,

FIG. 4 illustrates the result of monitoring,

FIG. 5 shows a calibration method,

FIG. 6 shows another calibration method,

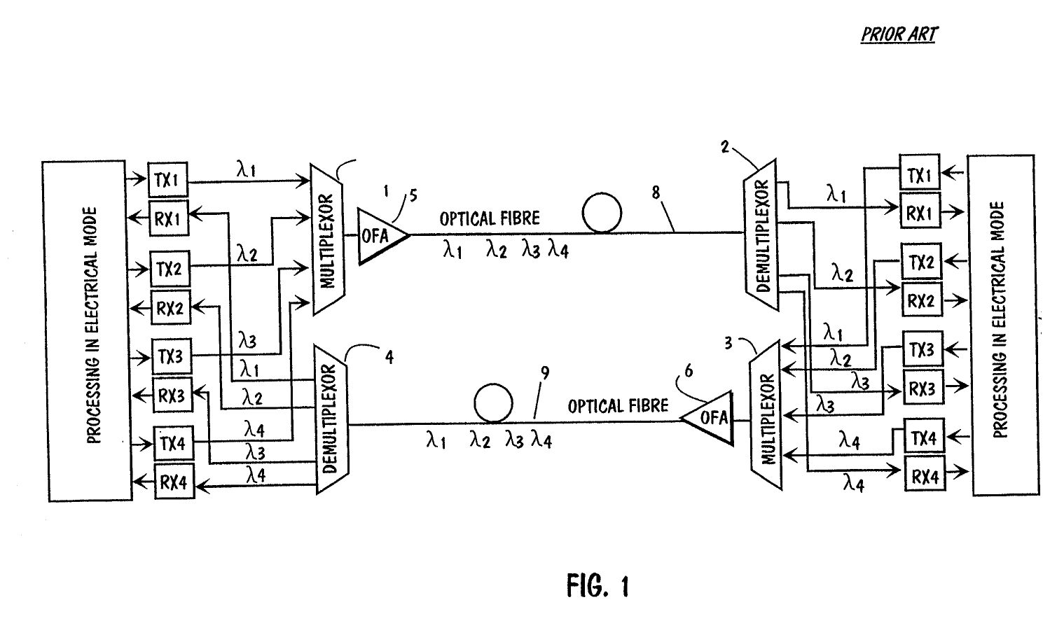

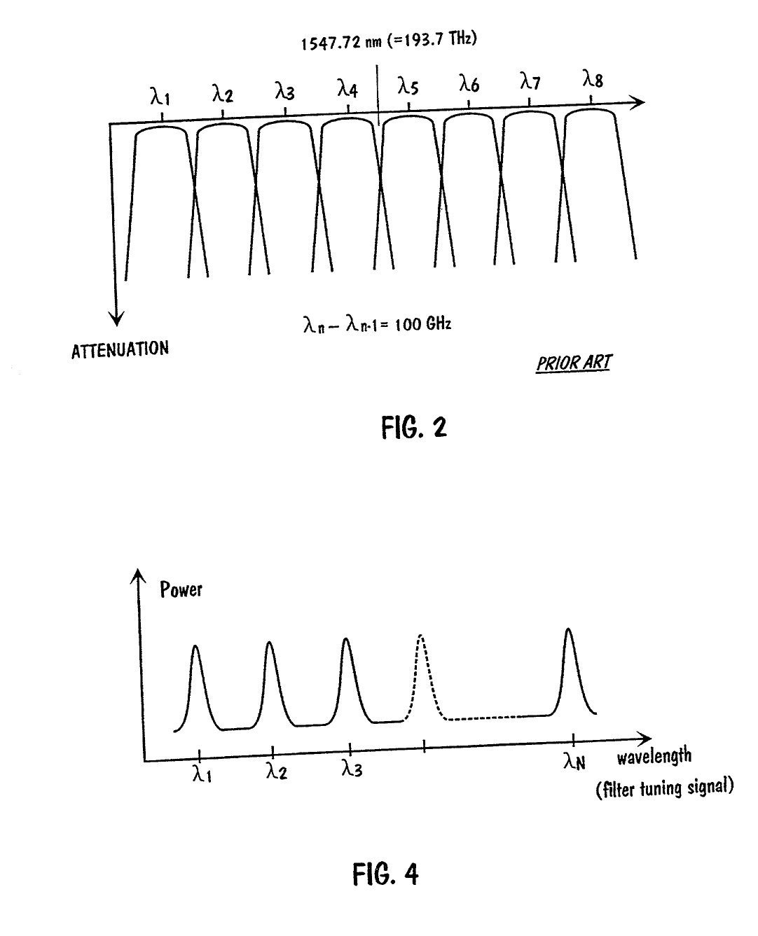

### DETAILED DESCRIPTION OF THE INVENTION

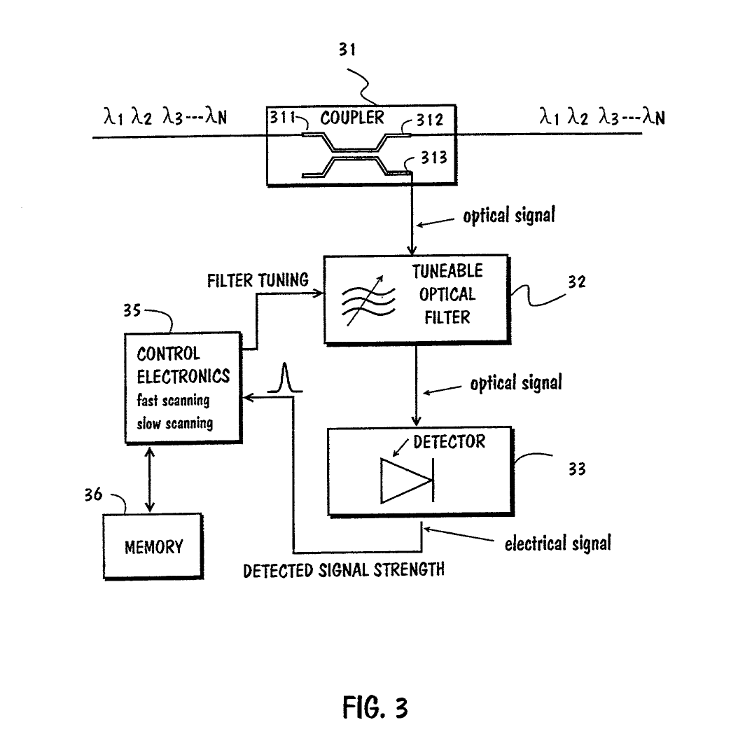

The blocks of a wavelength monitor in accordance with the invention is shown schematically in FIG. 3. From a signal travelling along optical fibre 30 and including n light waves, the wavelengths of which are λ₁, λ₂, λ₃, . . . λ_{N}, a sample is taken continuously, e.g. by a coupler 31. As is known, the coupler transfers a part (of the power arriving in input 311 to output gate 312 and a part 1-α to gate 313. The coupler is dimensioned so that the value of factor a is as close as possible to number 1, a typical value being 0.90-0.95. Thus, 5-10% of the combined signal travelling in the optical fibre is taken out from the fibre.

This optical signal, which thus contains the same wavelengths as the combined signal travelling in the fibre, is conducted to a tuneable optical filter 32 belonging to the monitor unit.

The filter is a narrowband filter having some suitable structure known in the art. One useable filter is e.g. the known Fabry-Perot filter. It the light flux arrives. A part of it penetrates the opposite surface of the cavity, but a part is reflected back in its direction of arrival. It traverses the cavity, but is again reflected from the surface in the direction of arrival towards the opposite surface, which a part of the wave penetrates and is summed with the wave which penetrated earlier. If the back-and-forth length of the cavity is a multiple of one-half of the wavelength, then all waves which have penetrated the cavity are in the same phase and they strengthen one another.

The Fabry-Perot filter can be made controllable by changing the length of the cavity. The length can be changed by moving mechanically one of the mirrors located on the cavity surface. Another method is to bring piezoelectric material into the filter cavity. By bringing an external filter tuning into it from the control electronics circuit 34, the material will shrink, whereby the resonance frequency of the filter will change. Thus, by changing the control voltage the resonance frequency of the cavity is changed. Admittedly, hysteresis and thermal instability are drawbacks of the piezoelectric filter.

The optical signal arriving from the tuneable filter 32 is conducted to a light detector 33. The detector is known in the art and it is made of semiconductor material, whereby photons arriving therein will bring about a current known as photocurrent in the circuit connected to the detector, wherein an electric voltage is effective. Thus, the higher the power of the optical signal arriving in the detector, the bigger photocurrent will be given by the detector.

The photocurrent arriving from the light detector is conducted into the control electronics circuit 34, which will process it in a manner to be described later.

The control electronics circuit forms the control signal for the controllable filter 32. The control range of the filter and thus the control range of the control signal are known either exactly, whereby no calibration is needed, or relatively, whereby calibration is necessary. Calibration will be described more closely later. The control signal can scan the entire control range by a quick scanning, or scanning may be slow. Quick scanning is advantageous in that the filter will have no time to heat. Hereby its thermal instability will not have time to affect very much, so the filter's wavelength response will change hardly at all. Slow scanning again is advantageous, if the interdependence of the filter's control signal and the pass band is exactly known and it is not affected by the temperature or the effect is known. Hereby scanning is made so slow that after a change of the control the filter will have sufficient time to stabilise into a new pass band. The control electronics circuit preferably includes a microprocessor monitoring the use of the control signal and processing the obtained measuring results in order to find out the wavelengths.

When the filter is directed through the whole scanning area, only the wavelengths of the current pass band will pass through the filter ending up in the light detector 33. As the scanning proceeds, the light detector gives a continuous electric signal, which is proportionate to the power of the incoming optical signal and which is conducted to the control electronics circuit.

FIG. 4 illustrates the power of the light detector's output signal as a function of the wavelength obtained from the filter. In the wavelength spectrum distinct power peaks can be seen at those wavelengths which are used by the channels of the optical fibre 30, FIG. 3. As it is known exactly which control voltage of the filter corresponds with which pass wavelength of the filter, it is possible as the scanning proceeds to store in memory 35 both the control voltage values and the power value coming from detector 33. The memory also contains information on the wavelength as a function of the control voltage, so upon completed scanning the information stored in the memory can be used for forming a curve as shown in FIG. 4 and for showing it

graphically in the display unit, or the information can be used in any desired manner in numeric processing. Instead of scanning the whole wavelength range one may as well examine only a part of the range or only individual wavelengths. In monitoring one wavelength the filter control is locked at a certain value. Hereby it can be seen immediately from the detector's output signal whether the monitored channel is in use or not, and also whether its wavelength is correct. The information may be used e.g. for giving an alarm in a trouble situation.

To ensure a faultless operation of the arrangement it is of essential importance to know exactly the dependence of the filter control and of the wavelength obtained from the filter output, in other words, the curve λ=f(c), wherein c is the filter control. If, for example, the filter manufacturer has stated this as an absolute dependence, then no calibration is needed. The dependence information is input directly to the memory.

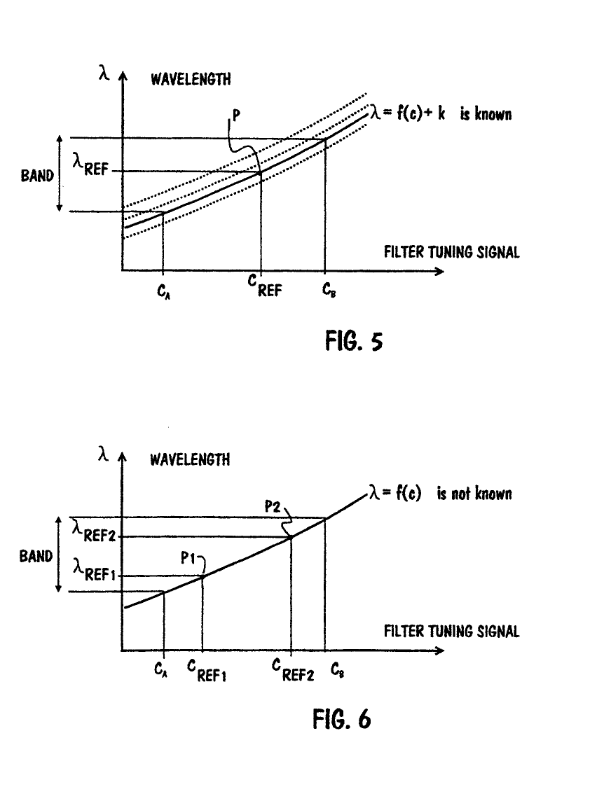

Calibration is needed, if the wavelength's relative dependence on the filter control is known. This is illustrated by the set of curves in FIG. 5. The shape of dependence curve λ=f(c) is known, whereby it is known that the real curve is someone of the set of curves indicated by dotted lines. Hereby the calibration is performed in such a way that the filter is given an exactly known control signal C_{REF} and a wavelength meter is used to measure the wavelength λ_{REF} obtained from the filter output. It is of course possible to proceed in such a way that a known wavelength is input to the filter and a calculation is made to find out at which control value the filter will let 10 the wavelength pass through. Point P corresponding to this pair C_{REF} λ_{REF} determines unambiguously the correct curve from the set of curves. Using the chosen curve, the band corresponding to the control voltage range C_{A}, . . . C_{B} is known, and the wavelength corresponding to each control value C is of course also known. The dependence values are stored in memory 35.

Calibration is also required, if the wavelength's relative or absolute dependence on the filter control is not known. This is illustrated in FIG. 6. Dependence curve λ=f(c) is assumed to be linear in the control range. Hereby the calibration is performed in such a way that the filter is given the exactly known control signals C_{REF1}, and C_{REF2} which are in the top and bottom ends of the control range, and a wavelength meter is used to measure the wavelengths λ_{REF1} and λ_{REF2} obtained from the filter output. The interdependence of control and wavelength is then indicated by the straight line through points P1 and P2 which correspond to the pairs C_{REF1}λ_{REF1} and C_{REF2} λ_{REF2}. The dependence values are stored in memory 35.

The calibration procedure in accordance with FIG. 6 can be used in a case of relative and unknown dependence also when it is probable that the control characteristics of the filter may change. Hereby the real dependence is checked from time to time using at least two check points.

The filter control signal can be arranged to change constantly from a minimum value and to its maximum value. If the control electronics circuit is purely digital, whereby the detector and the filter are connected to circuit DA by way of converters, it is advantageous to perform the scanning step-wise, whereby discrete value pairs will result. This method is advantageous, because when wishing to examine a certain individual wavelength

only, the control value corresponding to this is fetched from the memory and it is taken by way of converter DA to the filter.

1. Method of monitoring wavelengths of optical signals travelling in an optical fibre, characterized in the steps of:
conducting the optical signals to a narrowband optical filter which can be controlled by a control signal and in which the interdependence is known between the wavelength of the optical signal obtained from the output of the filter and the control signal,
converting the optical signal obtained from the output of the optical filter into an electric signal,
adjusting the filter by changing the control signal in such a way that the window formed by its pass band will slide within the wavelength range being examined,
determining the filter control signals corresponding to the peak values of the obtained electric signal, and determining the wavelengths corresponding the control signals.

2. Method as defined in claim 1, characterized in that the filter control signal is an electric signal.

3. Method as defined in claim 1, characterized in that the dependence of the wavelength obtained from the filter output on the filter control signal is stored in a memory in advance.

4. Method as defined in claim 3, characterized in that the determination of filter control signals corresponding to peak values of the electric signal and the determination of corresponding wavelengths based on these is performed based on the dependence stored in the memory.

5. Method as defined in claim 1, characterized in that the filter control signal is adjusted so that the window formed by the pass band will slide over the wavelength range being examined.

6. Method as defined in claim 1, characterized in that the filter control signal is adjusted so that the window formed by the pass band will be transferred to the desired wavelength.

7. Arrangement for monitoring wavelengths of optical signals travelling in an optical fibre, characterized in that it includes:
a narrowband optical filter (32), which can be controlled by filter tuning, and in which the interdependence is known between the wavelength of the control signal and the wavelength of the optical signal obtained from the filter output, and to the input of which the optical signals to be examined are conducted,
a light detector (33), which is connected to the output of the optical filter (32) and which converts the optical signal into an electric signal,
a control electronics circuit (34), which is connected on the one hand to the control input of the filter to give a filter tuning signal and on the other hand to the light detector to receive the electric signal given by it.

8. Arrangement as defined in claim 7, characterized in that the control electronics circuit forms a control signal, the value of which scans sliding over the entire control range.

9. Arrangement as defined in claim 7, characterized in that the control electronics circuit forms a control signal, the value of which obtains desired values only.

10. Arrangement as defined in claim 7, characterized in that it also includes storing means (35) storing the interdependence between the control signal and the wavelength of the optical signal obtained from the filter output.

11. Arrangement as defined in claim 8 or 9, characterized in that the control electronics circuit includes a microprocessor, which from the electric signal obtained from the light detector determines filter control signals corresponding to its peak values as well as the corresponding wavelengths based on these.

12. Arrangement as defined in claim 7, characterized in that it includes an optical directional coupler (31), which separates a part of the light power travelling in the optical fibre to be conducted to the input of the controllable filter.
